(19) United States
(12) Patent Application Publication
(10) Pub. No.: US 2025/0378277 A1
(43) Pub. Date: Dec. 11, 2025

(54) TEXT CLASSIFICATION

(71) Applicant: MASHANG CONSUMER FINANCE CO., LTD., Chongqing (CN)

(72) Inventors: Hongyu ZHAO, Chongqing (CN); Kexin LI, Chongqing (CN)

(21) Appl. No.: 18/989,947

(22) Filed: Dec. 20, 2024

(30) Foreign Application Priority Data
Jun. 7, 2024 (CN) 202410741412.4

(51) Int. Cl. G06F 40/35; G06N 20/00

(52) U.S. Cl. CPC G06F 40/35; G06N 20/00

(57) ABSTRACT

In a text classification method, an input text and scenario information corresponding to the input text is received. Semantic enhancement processing on the input text is performed based on the scenario information to obtain a semantic enhancement result. The semantic enhancement result is encoded to obtain text encoding. Non-linear mapping processing is applied on the text encoding to obtain text classification results of the input text.

### RELATED APPLICATION

This application claims priority to Chinese Patent Application No. 202410741412.4, filed on Jun. 7, 2024, which is incorporated herein by reference in its entirety.

### FIELD OF THE TECHNOLOGY

The present application relates to the technical field of natural language processing, including text classification.

### BACKGROUND OF THE DISCLOSURE

In a related technology, a deep learning-based text classification method trains data through deep learning models, such as convolutional neural networks. The accuracy of text classification may be affected by the amount of data and the number of training iterations. Further, in the process of text classification, noise will inevitably be introduced, affecting the accuracy of the text classification.

### SUMMARY

Aspects of the present disclosure provide a text classification method, a training method, and an apparatus for a text classification model, which can improve the accuracy of text classification.

Technical solutions of the present disclosure may be implemented as follows:

An aspect of this disclosure provides a text classification method. An input text and scenario information corresponding to the input text is received. Semantic enhancement processing on the input text is performed based on the scenario information to obtain a semantic enhancement result. The semantic enhancement result is encoded to obtain text encoding. Non-linear mapping processing is applied on the text encoding to obtain text classification results of the input text.

An aspect of this disclosure provides a text classification model training method. A first training dataset including a sample text, a first category label corresponding to the sample text, and scenario information corresponding to the sample text is obtained. Using an initialized text classification model, semantic enhancement processing on the sample text is performed based on the corresponding scenario information to obtain a semantic enhancement result. The semantic enhancement result is encoded through the initialized text classification model to obtain text encoding corresponding to the sample text. Non-linear mapping processing is performed on the text encoding to obtain a text classification result corresponding to the sample text. A loss value is calculated based on the text classification result and the first category label. Parameters of the initialized text classification model are updated based on the loss value to obtain a trained text classification model.

An aspect of this disclosure provides an apparatus. The apparatus includes processing circuitry that is configured to receive an input text and scenario information corresponding to the input text. The processing circuitry is configured to perform semantic enhancement processing on the input text based on the scenario information to obtain a semantic enhancement result. The processing circuitry is configured to encode the semantic enhancement result to obtain text encoding. The processing circuitry is configured to apply non-linear mapping processing on the text encoding to obtain a text classification result of the input text.

Aspects of the present disclosure can have the following beneficial effects:

Through the scene information of the input text, the input text is semantically enhanced in an adaptive manner to the scene information. Compared with the related art that simply classifies based on the text encoding of the input text, the text encoding obtained based on semantic enhancement processing can more fully represent the semantics of the input text in various scenarios, reduce the influence of noise in the input text, and thus improve the accuracy of the text classification results obtained by non-linear mapping based on text encoding.

### BRIEF DESCRIPTION OF THE DRAWINGS

FIG. 1 is a schematic diagram of the structure of a text classification system architecture according to an embodiment of the present disclosure;

FIG. 2A is a first structural diagram of a server according to an embodiment of the present disclosure;

FIG. 2B is a second structural diagram of a server according to an embodiment of the present disclosure;

FIG. 2C is a schematic diagram of text classification model selection in a text classification method according to an embodiment of the present disclosure;

FIG. 3A illustrates a first flowchart of a text classification method according to an embodiment of the present disclosure;

FIG. 3B illustrates a second flowchart of a text classification method according to an embodiment of the present disclosure;

FIG. 3C illustrates a third flowchart of a text classification method according to an embodiment of the present disclosure;

FIG. 3D illustrates a fourth flowchart of a text classification method according to an embodiment of the present disclosure;

FIG. 3E illustrates a fifth flowchart of a text classification method according to the embodiment of the present disclosure;

FIG. 3F illustrates a sixth flowchart of a text classification method according to the embodiment of the present disclosure;

FIG. 3G illustrates a seventh flowchart of a text classification method according to the embodiment of the present disclosure;

FIG. 3H illustrates an eighth flowchart of a text classification method according to the embodiment of the present disclosure;

FIG. 3I illustrates a ninth flowchart of a text classification method according to an embodiment of the present disclosure;

FIG. 4A illustrates a first flowchart of a method for training a text classification model according to an embodiment of the present disclosure;

FIG. 4B illustrates a second flowchart of a training method of a text classification model according to an embodiment of the present disclosure;

FIG. 5 illustrates a flowchart of a text classification method in a customer service scenario according to an embodiment of the present disclosure;

FIG. 6A illustrates a flowchart showing a principle of removing label noise according to an embodiment of the present disclosure;

FIG. 6B illustrates a flowchart of training and prediction of a text classification model according to an embodiment of the present disclosure.

It should be pointed out that the above-mentioned “first” and “second” are only used to distinguish different solutions, and do not represent the degree of superiority or inferiority of the solutions or the priority in the implementation process.

### DETAILED DESCRIPTION

In order to make the purpose, technical solutions and advantages of the present disclosure clearer, the present disclosure will be further described in detail below in conjunction with the accompanying drawings. The described embodiments should not be regarded as limiting the present disclosure. Other embodiments are within the scope of this disclosure.

In the following description, reference is made to “some embodiments,” which describe a subset of all possible embodiments, but it will be understood that “some embodiments” may be the same subset or different subsets of all possible embodiments and may be combined with each other without conflict.

In the following description, the terms “first\second\third” involved are merely used to distinguish similar objects and do not represent a specific ordering of the objects. It can be understood that “first\second\third” can be interchanged with a specific order or sequence where permitted, so that the embodiments of the present disclosure described here can be implemented in an order other than that illustrated or described here.

In the embodiments of the present disclosure, the term “module” or “unit” refers to a computer program or a part of a computer program that has a predetermined function and works together with other related parts to achieve a predetermined goal, and can be implemented in whole or in part by using software, hardware (e.g., processing circuits/circuitry or memories), or a combination thereof. Similarly, processing circuitry, such as a processor (or multiple processors or memories), can be used to implement one or more modules or units. In addition, each module or unit can be part of an overall module or unit that includes the function of the module or unit.

Unless otherwise defined, all technical and scientific terms used in the embodiments of the present disclosure have the same meanings as those commonly understood by those skilled in the art. The terms used in the embodiments of the present disclosure are only for the purpose of describing the embodiments of the present disclosure and are not intended to limit the present disclosure.

Before further describing the embodiments of the present disclosure, examples of the nouns and terms involved in the embodiments of the present disclosure are explained. The descriptions of the terms are provided as examples only and are not intended to limit the scope of the disclosure.

1) Scenario information is used, for example, to indicate the disclosure scenario corresponding to the text classification of the input text, so as to help the text classification model better understand the content of the input text and make more accurate classification decisions. Taking the customer service scenario in the financial lending field as an example, scenario information may include: judging whether the person answering the phone is the customer himself, judging the relationship between the person answering the phone and the customer (e.g., friends, colleagues, etc.), judging the situation of the person answering the phone, etc. (e.g., the person answering the phone refuses to help the agent to pass on the message to the customer, the person answering the phone helps the agent to pass on the message to the customer, etc. Here, the agent refers to the operator in the financial institution in the customer service scenario).

2) Key text may refer to the information or text part in the input text that plays a decisive role in the text classification task. Key text contains rich information, carries important meaning, and plays a key role in understanding the content of the entire input text.

3) Call summary may refer to the process in which customer service personnel use text classification models to summarize the entire conversation with customers in customer service scenarios, generating one or more text classification results, thereby helping customer service personnel better understand customer needs, questions, and feedback, and respond and handle them more effectively.

4) Loan borrower, such as a borrower or a customer, may refer to an enterprise, institution or individual that borrows monetary funds from a lender by using its own credit or property as guarantee, or using a third party as collateral, in a credit activity.

5) Loan contact person, or contact person, may refer to the person who helps contact the borrower when the lending institution is unable to contact the borrower. The contact person does not bear any loan responsibility.

6) Lender may refer to a person or financial institution that uses credit funds or own funds to lend to borrowers in lending activities, generally referring to commercial banks, financial institutions, etc.

7) Automatic Speech Recognition (ASR) may include a speech technology that uses computers to recognize speech signals generated by people speaking over the phone or through a microphone. ASR data refers to the text data after speech recognition.

In a related technology, the deep learning-based text classification method trains data through deep learning models such as convolutional neural networks. The accuracy of text classification is affected by the amount of data and the number of training iterations. In the process of text classification, noise will inevitably be introduced, affecting the accuracy of text classification.

In order to solve the above problems, embodiments of the present disclosure include a text classification method, a training method, an apparatus, a device, a computer-readable storage medium and a computer program product for a text classification model, which can improve the accuracy of text classification.

An electronic device provided in the embodiments of the present disclosure can be implemented as various types of terminal devices such as laptop computers, tablet computers, desktop computers, set-top boxes, smart phones, smart speakers, smart watches, smart TVs, and vehicle-mounted terminals, and can also be implemented as a server.

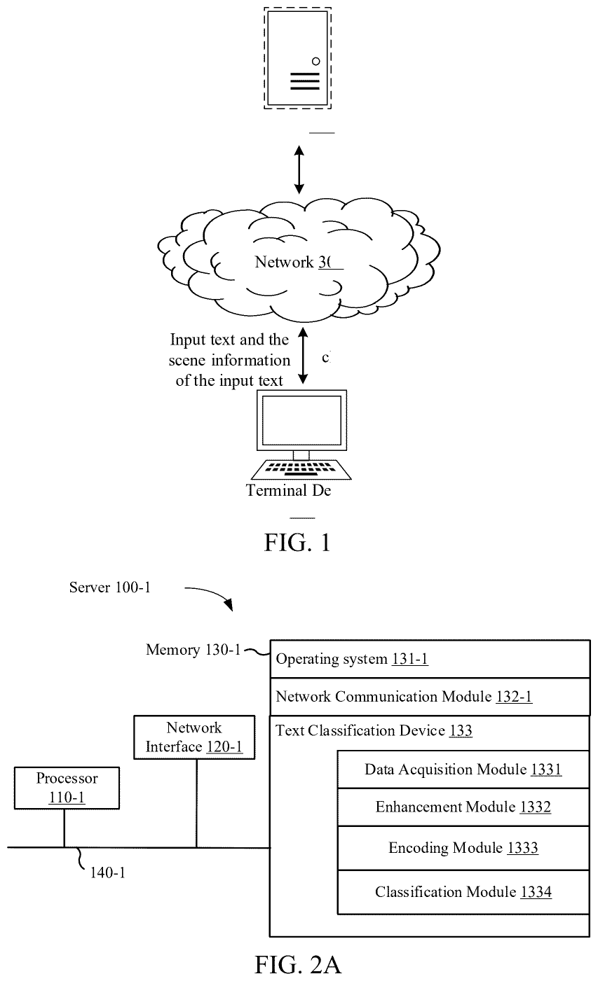

FIG. 1 is a schematic diagram of a structure of a text classification system architecture provided by an embodiment of the present disclosure, and FIG. 1 involves a server 100, a terminal device 200, and a network 300. The terminal device 200 is connected to the server 100 via the network 300. The network 300 may be a wide area network or a local area network, or a combination of the two.

Some embodiments of the present disclosure can be implemented collaboratively by a server and a terminal device. For example, the server 100 obtains a text classification model through the training method of the text classification model, the terminal device 200 sends the input text and the scene information of the input text to the server 100, and the server 100 obtains a text classification result through the text classification method, and sends the text classification result to the terminal device 200.

The server 100 may be a single server. In this case, the text classification method and the text classification model training method may be implemented by the same server. The server 100 may also be a server cluster. In the case where the server 100 is a server cluster, the text classification method and the text classification model training method may be implemented by different servers, which is not limited in the embodiments of the present disclosure.

Other embodiments can be implemented by a terminal device alone. The terminal device 200 sends a request to the server 100, and the server 100 receives the request and sends a text classification model for performing the text classification method to the terminal device 200. The terminal device 200 receives the text classification model sent by the server and downloads it locally, and obtains the text classification result corresponding to the input text through the text classification model.

In some embodiments, the terminal device or server can implement the text classification method and the training method of the text classification model provided by the embodiment of the present disclosure by running various computer executable instructions or computer programs. For example, the computer executable instructions can be commands, machine instructions or software instructions at the microprogram level. The computer program can be a native program or software module in the operating system. In short, the above-mentioned computer executable instructions can be instructions in any form, and the above-mentioned computer program can be an application program, module or plug-in in any form, and the terminal device includes but is not limited to mobile phones, computers, intelligent voice interaction devices, smart home appliances, vehicle-mounted terminals, etc.

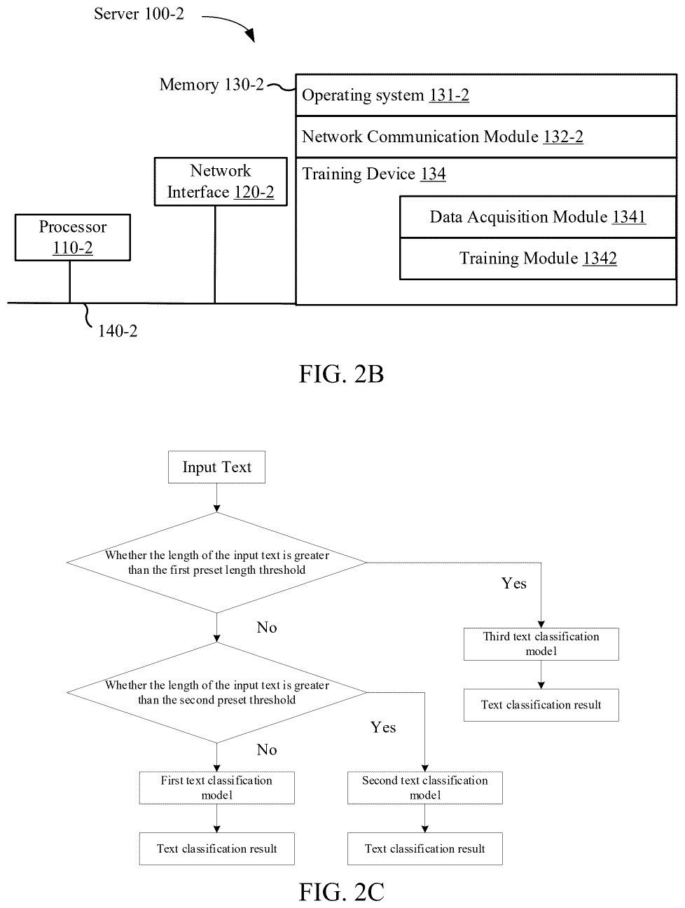

Taking a server for text classification as an example, see FIG. 2A, which is a first structural diagram of a server provided in an embodiment of the present disclosure. The server 100-1 shown in FIG. 2A includes: at least one processor 110-1 (e.g., processing circuitry), a memory 130-1 (e.g., a non-transitory computer-readable storage medium), and at least one network interface 120-1. The various components in the server 100-1 are coupled together through a bus system 140-1. It can be understood that the bus system 140-1 is used to achieve connection and communication between these components. In addition to the data bus, the bus system 140-1 also includes a power bus, a control bus, and a status signal bus. However, for the sake of clarity, various buses are labeled as bus system 140-1 in FIG. 2A.

Processor 110-1 may be an integrated circuit chip having signal processing capabilities, such as a general-purpose processor, a digital signal processor (DSP), or other programmable logic devices, discrete gate or transistor logic devices, discrete hardware components, etc. For example, the general-purpose processor may be a microprocessor or any conventional processor, etc.

Memory 130-1 may be removable, non-removable, or a combination thereof. Examples of hardware devices include solid-state memory, hard disk drives, optical disk drives, etc. Memory 130-1 may include one or more storage devices that are physically remote from processor 110-1.

The memory 130-1 includes a volatile memory or a non-volatile memory, and may also include both volatile and non-volatile memories. The non-volatile memory may be a read-only memory (ROM), and the volatile memory may be a random access memory (RAM). The memory 130-1 is intended to include any suitable type of memory.

In some embodiments, the memory 130-1 is capable of storing data to support various operations, examples of which include programs, modules, and data structures, or a subset or superset thereof, as described below.

Operating system 131-1 may include system programs for processing various basic system services and performing hardware-related tasks, such as a framework layer, a core library layer, a driver layer, etc., for implementing various basic services and processing hardware-based tasks.

A network communication module 132-1 may be used to reach other electronic devices via one or more (wired or wireless) network interfaces 120-1, network interfaces 120-1 include: Bluetooth, Wireless LAN (e.g., Wi-Fi), Universal Serial Bus (USB), etc.

In some embodiments, the device provided in the embodiments of the present disclosure can be implemented in software. FIG. 2A shows a text classification device 133 stored in the memory 130-1, which can be software in the form of a program and a plug-in, including the following software modules: a data acquisition module 1331, an enhancement module 1332, an encoding module 1333, and a classification module 1334. These modules are logical, so they can be combined in various manner or further split according to the functions implemented. Examples of the functions of each module will be described below.

Taking the server for training the text classification model as an example, refer to FIG. 2B, which is a second structural diagram of the server provided in an embodiment of the present disclosure. The server 100-2 shown in FIG. 2B includes: at least one processor 110-2, a memory 130-2 and at least one network interface 120-2. The various components in the server 100-2 are coupled together through a bus system 140-2. It can be understood that the bus system 140-2 is used to realize the connection and communication between these components. In addition to the data bus, the bus system 140-2 also includes a power bus, a control bus and a status signal bus. However, for the sake of clarity, various buses are marked as bus system 140-2 in FIG. 2B. For example descriptions of the processor 110-2 and the memory 130-2, reference maybe made to the descriptions above, which will not be repeated here.

In some embodiments, the device provided in the embodiments of the present disclosure can be implemented in software. FIG. 2B shows a training device 134 of a text classification model stored in the memory 130-2, which can be software in the form of a program and a plug-in, including the following software modules: a data acquisition module 1341 and a training module 1342. These modules are logical, so they can be combined in various manners or further split according to the functions implemented. The functions of each module will be described below.

In other embodiments, the device provided in the embodiments of the present disclosure can be implemented in hardware. As an example, the device provided in the embodiments of the present disclosure can be a processor in the form of a hardware decoding processor, which is programmed to execute the text classification method or the training method of the text classification model provided in the embodiments of the present disclosure. For example, the processor in the form of a hardware decoding processor can adopt one or more application specific integrated circuits (Application Specific Integrated Circuit, ASIC), digital signal processors (Digital Signal Processor, DSP), programmable logic devices (Programmable Logic Device, PLD), complex programmable logic devices (Complex Programmable Logic Device, CPLD), field programmable gate arrays (Field-Programmable Gate Array, FPGA) or other electronic components.

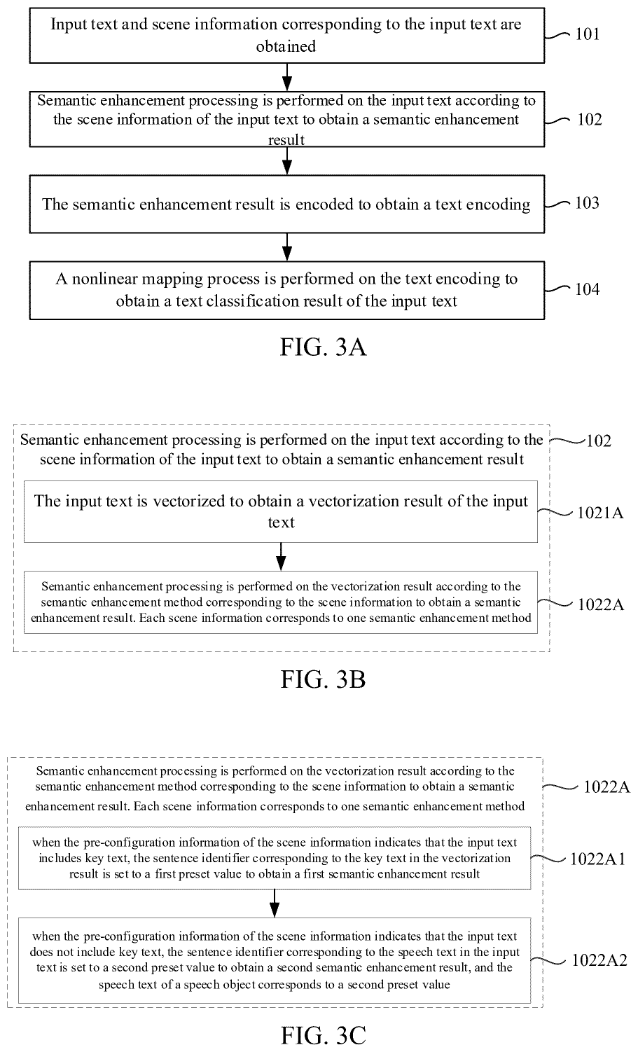

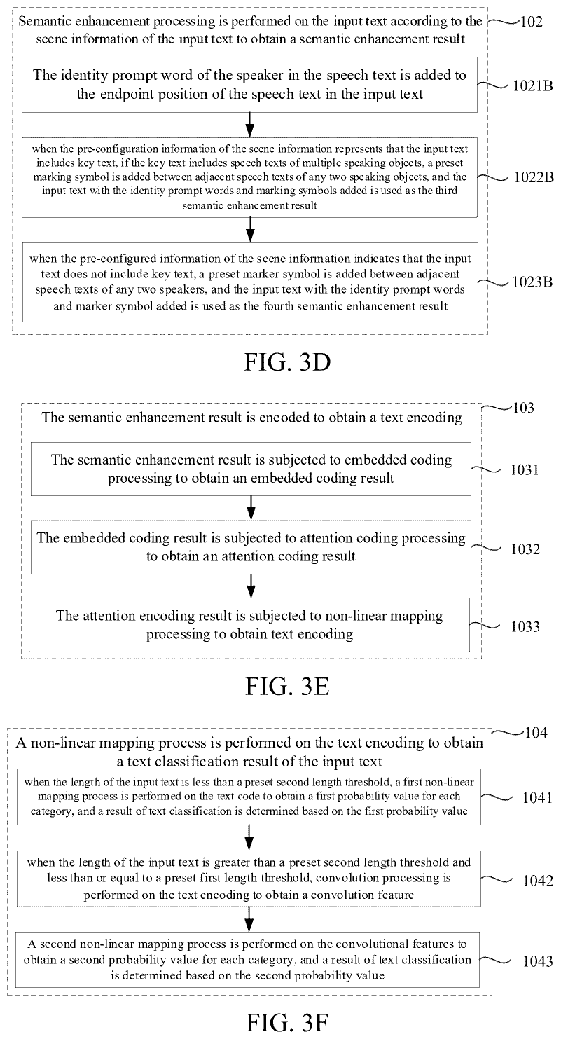

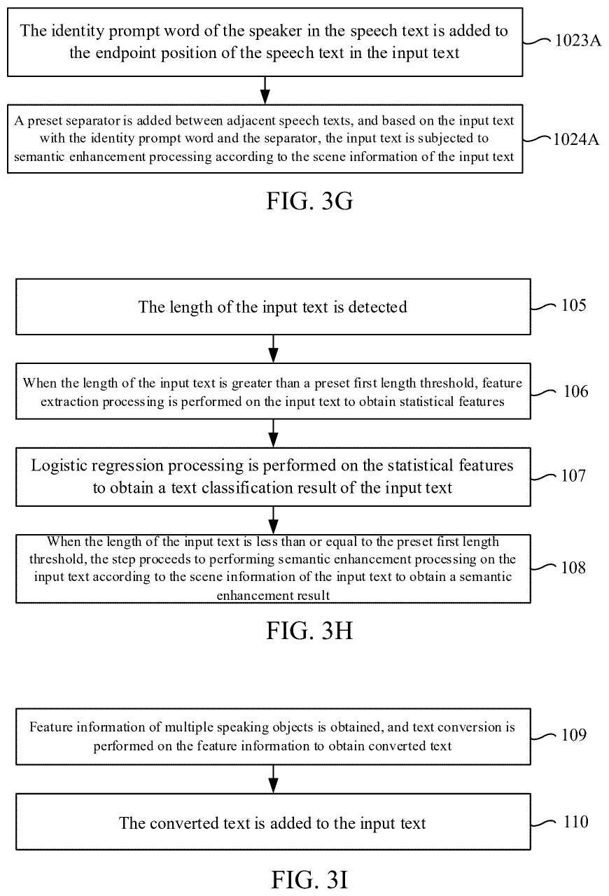

A server as the execution subject is used as an example in the description to follows to illustrate the text classification method provided in an embodiment of the present disclosure. FIG. 3A illustrates a first flow chart of the text classification method according to an embodiment of the present disclosure, which will be explained in combination with the steps shown in FIG. 3A.

In step 101, input text and scene information corresponding to the input text are obtained. For example, an input text and scenario information corresponding to the input text is received.

In some embodiments, input text and scenario information corresponding to the input text are obtained. Taking the customer service scenario as an example, the input text may be, for example, “Customer: Hello. Agent: Are you Zhao XX? Customer: Hello. . . . Agent: Have you been in contact with Chen XX recently? Customer: I don't know Chen XX. Agent: Aren't you Zhao XX? Customer: I am not,” and the corresponding scenario information may be “determine whether the party answering the phone is the customer himself,” where the agent refers to the switchboard staff in a financial institution in the customer service scenario.

In step 102, semantic enhancement processing is performed on the input text according to the scene information of the input text to obtain a semantic enhancement result. For example, semantic enhancement processing on the input text is performed based on the scenario information to obtain a semantic enhancement result.

In some embodiments, referring to FIG. 3B, step 102 shown in FIG. 3A can be implemented by the following steps 1021A to 1022A, which are described in further detail below.

In step 1021A, the input text is vectorized to obtain a vectorization result of the input text. For example, vectorization processing is performed on the input text to obtain a vectorization result of the input text.

Continuing with the above example, the input text can be segmented by the special symbol “[September].” The input text after adding the special symbol can be expressed as “Customer: Hello. [September] Agent: Are you Zhao XX? [September] Customer: Hello . . . [September] Agent: Have you contacted Chen XX recently? [September] Customer: I don't know Chen XX. [September] Agent: Aren't you Zhao XX? [September] Customer: I am not.” Next, the input text is segmented to obtain multiple text minimum units (e.g., words, numbers, punctuation marks or other symbols, which can be represented by tokens). Each token is vectorized to obtain the vectorized result of the input text. The vectorized result of the input text can be expressed by formula (1):

$${Z}^{′} = BertTokeni 𝓏 er ( X ) \qquad ( 1 )$$

X represents input text, BertTokenizer represents the tokenizer used for vectorization processing. Z′ represents the vectorized result of the input text.

For example, Z′ can include the following three parts:

{
‘input_ids': [101, 711, 784, 720, 2769, 3680, 3613, ..., 102],
‘token_type_ids': [0, 0, 0, 0, 0, 0, 0, 0, 0, 0, 0, 0, 0, 0, ..., 0],
‘attention_mask’: [1, 1, 1, 1, 1, 1, 1, 1, 1, 1, 1, 1, 1, 1, ..., 1]
}

Among them, input_ids' represents the input token sequence after BertTokenizer processing. Each token is mapped to the corresponding id. In the above example, the input token sequence is [101, 711, 784, . . . ], each id corresponds to a specific token in the vocabulary. Here, the vocabulary stores the numerical code corresponding to each token, so that the words in the text are converted into numerical representations according to the vocabulary. The tokenizer represents the token sequence through these numerical codes;

‘token_type_ids’*(sentence identifiers) are used to distinguish different sentences in the input token sequence. Each token is assigned a corresponding sentence number. In the above example, all tokens are marked as 0, indicating that they belong to the same sentence;

‘attention_mask’ is used to indicate which tokens are part of the real input and which are filled in. For real input tokens, the corresponding attention_mask value is 1; for filled tokens, the corresponding attention_mask value is 0. In the above example, all tokens are part of the real input, so the attention_mask is 1.

In step 1022A, semantic enhancement processing is performed on the vectorization result according to the semantic enhancement method corresponding to the scene information to obtain a semantic enhancement result. Each scene information corresponds to one semantic enhancement method. For example, the semantic enhancement processing is performed on the vectorization result based on which of a plurality of semantic enhancements is determined to correspond to the scenario information to obtain the semantic enhancement result, each of the plurality of semantic enhancements being associated with a different type of scenario information. The scene information may include scenario or context information related to the input text for example.

In some embodiments, the vectorization result in step 1022A is subjected to semantic enhancement processing to obtain a semantic enhancement result, which can be expressed by formula (2):

$$Z = enhance ( {Z}^{′} ) \qquad ( 2 )$$

Z′express vectorized result, enhance indicates semantic enhancement processing, Z represents the semantic enhancement result.

In some embodiments, the input text includes the speech text corresponding to the speech object, referring to FIG. 3C, step 1022A shown in FIG. 3A can be implemented by following steps 1022A1 to 1022A2, which are described in further detail below.

In step 1022A1, when the pre-configuration information of the scene information indicates that the input text includes key text, the sentence identifier corresponding to the key text in the vectorization result is set to a first preset value to obtain a first semantic enhancement result. For example, when pre-configured information of the scenario information indicates the input text includes key text, a sentence identifier corresponding to the key text in the vectorization result is set with a first type of identifier to obtain a first semantic enhancement result.

In some embodiments, the statement identifier (token_type_ids) obtained in step 1021A may be set according to different scenario information. The token_type_ids settings (corresponding to pre-configured information) corresponding to different scenario information may be represented by Table 1:

TABLE 1

| Scene | Example | token_type_ids | | |
|---|---|---|---|---|
| Information | scenario | settings | Enter text | token_type_ids Setting result |
| Determine the | For example, | Default | Customer: Hello. | [0, 0, 0, 0, 0, 0, 1, 1, 1, 1, 1, 1, 1, 1, 1, 1, |
| relationship | the person | | [SEP]Agent: Are you | 1, 1, 10, 0, 0, 0, 0, 0, 1, 1, 1, 1, 1, 1, 1, |
| between the | answering the | | Zhao XX? | 1, 1, 1, 1, 1, 1, 1, 1, 1, 0, 0, 0, 0, 0, 0, 0, |
| person | phone says | | [SEP]Customer: | 0, 0, 0, 0, 1, 1, 1, 1, 1, 1, 1, 1, 1, 1, 1, |
| answering the | that they do | | Hello. . . . | 1, 0, 0, 0, 0, 0, 0, 0] |
| phone and the | not know the | | [SEP]Agent: Have | |
| customer | lender | | you contacted Chen | |
| | (customer) | | XX recently? | |
| | | | [SEP]Customer: I | |
| | | | don't know Chen | |
| | | | XX. [SEP]Agent: | |
| | | | Aren't you Zhao XX? | |
| | | | [SEP]Customer: I am | |
| | | | not. | |
| Determine | For example, | Key text first | Agent: Hello. | [. . . , 1, 1, 1, 1, 1, 1, 1, 1, 1, 1, 1, 1, 1, |
| whether the | the person | | [SEP]Customer: | 1, 0, 0, 0, 0, 0, 0, 0, 0, 0, |
| person | answering the | | Hello. [SEP]Agent: | 0, 0, 0, 0, 0, . . .] |
| answering the | phone is not | | Are you Mr. Chen | |
| phone is the | the lender | | XX? | |
| customer | (customer) | | | |
| himself | | | | |
| Determine the | For example, | Key text | . . . [SEP] Agent: | [. . . , 0, 0, 0, 0, 0, 0, 0, 0, 0, 0, 0, 0, 0, |
| situation of the | the contact | comes after | Could you please tell | 0, 1, 1, 1, 1, 1, 1, 1, 1, 1, 1, 1, 1, . . .] |
| person | person (the | | XX. [SEP] Customer: | |
| answering the | person | | I can't find him. | |
| phone | answering the | | | |
| | phone) is | | | |
| | reluctant to | | | |
| | inform the | | | |
| | lender about a | | | |
| | loan | | | |
| | delinquency. | | | |

In the case where the scene information represents that the key text in the input text is located in the first part of the input text, the sentence identifier of the first preset length starting from the head in the vectorization result is set to the first preset value to obtain a first semantic enhancement result. For example, assuming that the length of the input text is 1024 tokens, the first preset length is 512 tokens, and the key text is located in the first part (e.g., the first half) of the input text, according to the case where the key text is in front in the token_type_ids setting in Table 1, the token_type_ids corresponding to the length of 512 tokens starting from the head in the vectorization result should be set to 1 (the first preset value), and the remaining token_type_ids keep the default value of 0, so the setting result of token_type_ids can be: “[ . . . , 1,1,1,1,1,1,1,1,1,1,1,1,1,1,0,0,0,0,0,0,0,0,0,0,0,0,0,0,0,0, . . . ].”

When the scene information represents that the key text in the input text is located in the second part of the input text, the sentence identifier of the second preset length starting from the tail in the vectorization result is set to the first preset value to obtain a first semantic enhancement result. For example, assuming that the length of the input text is 1024 tokens, the second preset length is 512 tokens, and the key text is located in the second part (e.g., the second half) of the input text, according to the case where the key text is at the end in the token_type_ids setting in Table 1, the token_type_ids corresponding to the length of 512 tokens starting from the tail in the vectorization result should be set to 1 (the first preset value), and the remaining token_type_ids maintain the default value of 0. Therefore, the setting result of token_type_ids can be: “[ . . . ,0,0,0,0,0,0,0,0,0,0,0,0,0,0,1,1,1,1,1,1,1,1,1,1,1,1,1, . . . ].”

In step 1022A2, when the pre-configuration information of the scene information indicates that the input text does not include key text, the sentence identifier corresponding to the speech text in the input text is set to a second preset value to obtain a second semantic enhancement result, and the speech text of a speech object corresponds to a second preset value. For example, when pre-configuration information of the scenario information indicates the input text does not include the key text, setting the sentence identifier corresponding to the speech text in the input text is set with a second type of identifier to obtain a second semantic enhancement result. In an example, the plurality of speakers are associated with different values of the second type of identifier.

In an example, it is assumed that the input text corresponds to two speech objects, which are recorded as the first speech object and the second speech object. The first speech object can be an agent, and the second speech object can be a customer. When the scene information represents that the input text does not include key text, the sentence identifier corresponding to the speech text corresponding to the first speech object in the input text (e.g., the speech text corresponding to the agent in the above example) is set to the second preset value, and the sentence identifier corresponding to the speech text corresponding to the second speech object (e.g., the speech text corresponding to the customer in the above example) is set to the default value to obtain the second semantic enhancement result. According to the “default situation” in the token_type_ids setting in Table 1 (corresponding to the situation where the scene information represents that the input text does not include key text), the token_type_id should be set according to the identity of the speech object. The value of the element in s is used to distinguish the speech texts corresponding to different speech objects. For example, the sentence identifier of the speech text corresponding to the agent is set to 1 (i.e., the second preset value corresponding to the agent's speech text is 1), and the sentence identifier of the speech text corresponding to the customer object is set to 0 (i.e., the second preset value corresponding to the customer's speech text is 0). Therefore, the setting result of token_type_ids can be: “[0,0,0,0,0,0,1,1,1,1,1,1,1,1,1,1,1,1,1,0,0,0,0,0,0,1,1,1,1,1,1,1,1,1,1,1,1,1,1,1,0,0,0,0,0,0,0,0,0,0,1, 1,1,1,1,1,1,1,1,1,1,1,1,0,0,0,0,0,0,0,0,0,0,1,1,1,1,1,1,1,1,1,1,0,0,0,0,0,0,0,0,0].”

In some other embodiments, referring to FIG. 3D, step 102 shown in FIG. 3A may be implemented by following steps 1021B to 1023B, which are described in further detail below.

In some embodiments, the semantic enhancement process is performed on the input text according to the scene information of the input text, and the semantic enhancement result is obtained, which can be expressed by formula (3):

$${X}^{′} = enhance ( X ) \qquad ( 3 )$$

X represents input text, enhance indicates semantic enhancement processing, X′ represents the semantic enhancement result.

In step 1021B, the identity prompt word of the speaker in the speech text is added to the endpoint position of the speech text in the input text. For example, identity prompt words of a plurality of speakers are added at endpoint positions of speech text in the input text.

In some embodiments, an identity prompt word of the speaking object of the speaking text is added to the endpoint position (e.g., the starting position or the ending position) of the speaking text in the input text.

Taking two speaking objects in a customer service scenario as an example, the input text may be, for example, “Hello. Are you Zhao XX? Hello. Have you contacted Chen XX recently? I don't know Chen XX. Aren't you Zhao XX? I'm not,” assuming that the identity prompt words are agent and customer, then the input text after adding the identity prompt words corresponding to the speaking objects of the speech text may be, for example, “Customer: Hello. Agent: Are you Zhao XX? Customer: Hello. . . . Agent: Have you contacted Chen XX recently? Customer: I don't know Chen XX. Agent: Aren't you Zhao XX? Customer: I'm not,” here, the input text may be segmented according to the endpoint positions in the input text to obtain multiple speech text paragraphs, and each speech text paragraph may be iterated and the corresponding identity prompt words may be added according to the parity, for example, the “agent” identity prompt word may be added at the starting position of the odd-numbered speech text paragraphs traversed, and the “customer” identity prompt word may be added at the starting position of the even-numbered speech text paragraphs traversed. The embodiment of the present disclosure does not limit the specific method of adding the identity prompt word.

In step 1022B, when the pre-configuration information of the scene information represents that the input text includes key text, if the key text includes speech texts of multiple speaking objects, a preset marking symbol is added between adjacent speech texts of any two speaking objects, and the input text with the identity prompt words and marking symbols added is used as the third semantic enhancement result. For example, when pre-configuration information of the scenario information indicates the input text includes key text, and the key text includes the speech text of multiple speakers, marker symbols are added between adjacent speech texts of any two speaker, and the input text with the added identity prompt words and the added marker symbols is used as a third semantic enhancement result.

In some embodiments, when the scene information represents that the input text includes key text, part of the text is cut from the input text according to a preset length as the key text. If the key text includes speech texts of multiple speakers, a preset marking symbol is added between the speech texts of the multiple speakers, and the input text with identity prompt words and marking symbols added is used as the third semantic enhancement result. For example, assuming that the length of the input text is 1024 tokens and the preset length is 512 tokens, when the key text is located in the first half of the input text, the key text is cut from the beginning with a length of 512 tokens according to the preset length. When the key text is located in the second half of the input text, the key text is cut from the end with a length of 512 tokens according to the preset length, and a preset marking symbol “|” is added between the speech texts of multiple speakers in the key text as the third semantic enhancement result.

For example, corresponding marking symbols may be set for input text according to different scene information, and the marking symbols (e.g., the marking symbol is “|”) settings corresponding to different scene information (pre-configuration information corresponding to the scene information) may be represented by Table 2:

TABLE 2

| Scene | Example | Special symbol | | |
|---|---|---|---|---|
| Information | scenario | settings | Enter text | Semantic enhancement results |
| Determine | For example, | Default | Hello. Are you | Customer: Hello. \|Agent: Are |
| the | the person | | Zhao XX? | you Zhao XX? \|Customer: |
| relationship | answering the | | Hello. . . . Have you | Hello. \|Agent: Have you |
| between the | phone says that | | contacted Chen XX | contacted Chen XX recently? |
| person | they do not | | recently? I don't | \|Customer: I don't know Chen |
| answering | know the | | know Chen XX. | XX. \|Agent: Aren't you Zhao |
| the phone | lender | | Aren't you Zhao | XX? \|Customer: I am not. |
| and the | (customer) | | XX? I am not. | |
| customer | | | | |
| Determine | For example, | Key text first | Hello. Hello. Are | Agent: Hello. \| Customer: |
| whether the | the person | | you Mr. Chen | Hello. \| Agent: Are you Mr. |
| person | answering the | | XX? . . . | Chen XX? . . . (without the \| at |
| answering | phone is not the | | | the end) |
| the phone | lender | | | |
| is the | (customer) | | | |
| customer | | | | |
| himself | | | | |
| Determine | For example, | Key text comes | . . . Please tell | (without \| at the front) . . . \|Agent: |
| the | the contact | after | XX. I can't find | Could you please tell XX? |
| situation of | person (the | | him. | \|Customer: I can't find him. |
| the person | person | | | |
| answering | answering the | | | |
| the phone | phone) is | | | |
| | reluctant to | | | |
| | inform the | | | |
| | lender about a | | | |
| | loan | | | |
| | delinquency. | | | |

In the case where the scene information represents that the key text in the input text is located in the first part of the input text, a preset marking symbol is added between the speech texts of the preset length starting from the head of the input text to obtain a third semantic enhancement result. For example, assuming that the length of the input text is 1024 tokens and the preset length is 512 tokens, when the key text is located in the first part (e.g., the first half) of the input text, according to the special symbol setting in Table 2, in which the key text is in the front, 512 tokens from the beginning should be intercepted according to the preset length as the key text, and a preset marking symbol “|” is added between the speech texts of multiple speech objects in the key text. Therefore, the semantic enhancement result can be: “Agent: Hello.|Customer: Hello.|Agent: Are you Mr. Chen XX? . . . (no|at the end)”;

When the scene information represents that the key text in the input text is located in the second part of the input text, a preset marking symbol is added between the speech texts of a preset length starting from the tail of the input text to obtain a third semantic enhancement result. For example, assuming that the length of the input text is 1024 tokens and the preset length is 512 tokens, when the key text is located in the second part (e.g., the second half) of the input text, according to the special symbol setting in Table 2 where the key text is at the end, 512 tokens from the tail should be truncated according to the preset length as the key text, and a preset marking symbol “|” is added between the speech texts of multiple speaking objects in the key text. Therefore, the semantic enhancement result can be: “(without|at the front) . . . |Agent: Please help to tell XX.|Customer: I can't find him.”

In step 1023B, when the pre-configured information of the scene information indicates that the input text does not include key text, a preset marker symbol is added between adjacent speech texts of any two speakers, and the input text with the identity prompt words and marker symbol added is used as the fourth semantic enhancement result. For example, when the pre-configuration information of the scenario information indicates the input text does not include the key text, the marker symbols are added between the adjacent speech texts of any two speakers, and the input text with the added identity prompt words and the added marker symbols is used as a fourth semantic enhancement result.

In some embodiments, taking the input text corresponding to two speech objects as an example, when the scene information represents that the input text does not include key text (corresponding to the default situation in Table 2), a preset marking symbol is added between adjacent speech texts, so that the semantic enhancement result can be: “Customer: Hello. | Agent: Are you Zhao XX? | Customer: Hello. | Agent: Have you contacted Chen XX recently? | Customer: I don't know Chen XX. | Agent: Aren't you Zhao XX? | Customer: I am not.”

Continuing to refer to FIG. 3A, in step 103, the semantic enhancement result is encoded to obtain a text encoding. For example, the semantic enhancement result is encoded to obtain text encoding.

In some embodiments, following formula (2), the semantic enhancement result is encoded to obtain text encoding, which can be expressed by formula (4):

$$H = BERT ( Z ) \qquad ( 4 )$$

Z represents the semantic enhancement result, BERT indicates the encoder used for encoding processing. H indicates the text encoding.

As an example, FIG. 2C is a schematic diagram of text classification model selection in the text classification method provided in an embodiment of the present disclosure. The semantic enhancement processing method can be selected according to the length of the input text. When the length of the input text is less than or equal to the second preset length threshold (e.g., 512 tokens), the input text can be regarded as a regular conversation text. At this time, the input text is semantically enhanced according to the scene information of the input text to obtain a semantic enhancement result, which can be achieved through the above steps 1021A to 1022A (corresponding to the first text classification model in FIG. 2C). In the semantic enhancement processing, when the length of the input text is greater than the second preset length threshold and less than or equal to the first length threshold (e.g., 2048 tokens), the input text can be regarded as a medium-length conversation text. The input text is semantically enhanced according to the scene information of the input text to obtain a semantic enhancement result, which can be achieved through the above steps 102B1 to 102B3 (corresponding to the second text classification model in FIG. 2C). In the semantic enhancement processing, when the text length of the input text is greater than the first length threshold, the input text can be regarded as an extra-long conversation text. At this time, since the content of the input text is large and the information it carries is relatively comprehensive, the input text does not need to be semantically enhanced. The input text can be classified through the third text classification model. The specific implementation method can be described in steps 106 to 107 below.

Among them, the semantic enhancement processing for regular conversations can be implemented by adopting the above steps 1021A to 1022A. This is because the text length of regular conversations is relatively short and carries less key information (key text). Therefore, the semantic enhancement method of steps 1021A to 1022A can be used to perform semantic enhancement based on the vectorization result to assist in obtaining the location of key information. Accordingly, understanding of the text content can be improved and the loss of key information can be reduced, thereby achieving the beneficial effect of improving the accuracy of text classification;

The semantic enhancement processing of medium and long conversations can be implemented using steps 102B1 to 102B3 above. This is because when compared to regular conversations, medium and long conversations are longer and carry relatively more key information. Therefore, unlike the more sophisticated semantic enhancement method based on vectorization results, semantic enhancement processing based on input text is adopted for medium and long conversations. The location of key information is obtained through the assistance of preset marking symbols, so as to better model the text content of the input text, thereby achieving the beneficial effect of improving the accuracy of text classification.

Through steps 1021A to 1022A and steps 1021B to 1023B, differentiated semantic enhancement processing is implemented according to the length of the input text and the scene information corresponding to the input text, thereby covering input texts of different lengths, and the beneficial effect of improving the representation ability of the input text by semantic enhancement results.

In some embodiments, referring to FIG. 3E, step 103 shown in FIG. 3A can be implemented by following steps 1031 to 1033, which are described in detail below.

In step 1031, the semantic enhancement result is subjected to embedded coding processing to obtain an embedded coding result. For example, embedded encoding is performed on the semantic enhancement result to obtain an embedded encoding result.

In some embodiments, the semantic enhancement result is subjected to an embedding coding process to obtain an embedding coding result. As an example, the embedding coding process may be at least one of word embedding coding and positional encoding.

In step 1032, the embedded coding result is subjected to attention coding processing to obtain an attention coding result. For example, attention encoding processing is performed on the embedded encoding result to obtain an attention encoding result.

In some embodiments, the embedded coding result is subjected to attention coding processing through an attention mechanism to obtain an attention coding result. For example, multi-level feature extraction is performed on the embedded coding result through multiple self-attention layers and feedforward neural network layers to obtain an attention coding result.

In step 1033, the attention encoding result is subjected to non-linear mapping processing to obtain text encoding. For example, the non-linear mapping processing is performed on the attention encoding result to obtain the text encoding.

In some embodiments, the attention encoding result can be non-linearly mapped using a non-linear activation function (e.g., ReLU, Sigmoid, or Tanh) to obtain a non-linear mapping result. The non-linear mapping result can also be dimensionally transformed according to the requirements of downstream tasks (e.g., by using dimensionality transformation methods such as principal component analysis (PCA) to transform high-dimensional non-linear mapping results into low-dimensional non-linear mapping results (i.e., text encoding) to make the text encoding easier to process and analyze) to obtain text encoding. The non-linear mapping helps the model learn more complex feature representations.

In some other embodiments, the semantic enhancement result is segmented to obtain a segmentation result set. Each segmentation in the segmentation result set is embedded and encoded to obtain a text encoding. Following formula (3), the semantic enhancement result is encoded to obtain a text encoding, which can be expressed by formula (5):

$$H = embedding ( {X}^{′} ) \qquad ( 5 )$$

X′ represents the semantic enhancement result, embedding indicates encoding processing (e.g., Word2Vec, etc.), H indicates the text encoding.

Continuing to refer to FIG. 3A, in step 104, a non-linear mapping process is performed on the text encoding to obtain a text classification result of the input text. For example, non-linear mapping processing is applied on the text encoding to obtain text classification results of the input text.

In some embodiments, the preset second length threshold is smaller than the preset first length threshold. Referring to FIG. 3F, step 104 shown in FIG. 3A can be implemented by following steps 1041 to 1043, which are described in detail below.

In step 1041, when the length of the input text is less than a preset second length threshold, a first non-linear mapping process is performed on the text code to obtain a first probability value for each category, and a result of text classification is determined based on the first probability value. For example, when the length of the input text is less than or equal to the second preset length threshold, first non-linear mapping processing is performed on the text encoding to obtain a first probability value for each classification category, and the text classification result is determined based on the first probability value.

In some embodiments, the length of the input text is detected. When the length of the input text is less than a preset second length threshold (e.g., 512 tokens), the text encoding is subjected to a first non-linear mapping process to obtain a first probability value for each category (e.g., a probability distribution is obtained by a Softmax function). The result of the text classification is confirmed based on the first probability value. For example, the category with the highest probability value is used as the text classification result corresponding to the input text. This can be expressed by formula (6):

$$C = Softmax ( WH ) \qquad ( 6 )$$

H Indicates the text encoding. W represents the parameters to be learned of the model, Softmax represents the activation function, C represents the text classification result.

In step 1042, when the length of the input text is greater than a preset second length threshold and less than or equal to a preset first length threshold, convolution processing is performed on the text encoding to obtain a convolution feature. For example, when the length of the input text is greater than the second preset length threshold and less than or equal to the first preset length threshold, convolution processing is performed on the text encoding to obtain a convolution feature.

In some embodiments, the length of the input text is detected. When the length of the input text is higher than a preset second length threshold (e.g., 512 tokens), the text encoding is convolved to obtain convolution features. For example, one-dimensional convolution (Conv1D) is used to process the text encoding to obtain convolution features. Here, the size and number of convolution kernels can be adjusted according to the specific task. The convolution features can also be pooled (e.g., maximum pooling or average pooling), and the features obtained by convolution and pooling can be integrated (e.g., splicing), and the integrated features are transferred to the processing of step 1043.

In step 1043, a second non-linear mapping process is performed on the convolutional features to obtain a second probability value for each category, and a result of text classification is determined based on the second probability value. For example, second non-linear mapping processing is performed on the convolution feature to obtain a second probability value for each classification category, and the text classification result is determined based on the second probability value.

In some embodiments, convolutional features can be aggregated and converted into high-order feature representations through one or more fully connected layers (Dense Layer). After the fully connected layer, a non-linear activation function, such as ReLU, Sigmoid, or Tanh, is applied to introduce non-linear characteristics. After the non-linear activation function, the output can be converted into a second probability value for each category through a Softmax layer, and the category with the highest second probability value is used as the text classification result corresponding to the input text.

In some embodiments, steps 1042 to 1043 can be expressed by formula (7):

$$C = TextCNN ( H ) \qquad ( 7 )$$

H Indicates the text encoding. TextCNN represents a convolutional neural network model for text classification (Convolutional Neural Network for Text Classification), used for execute step 1042 to step 1043, C represents the text classification result.

For example, step 1041 may correspond to the non-linear mapping processing method of the first text classification model in FIG. 2C above, and steps 1042 to 1043 may correspond to the non-linear mapping processing method of the second text classification model in FIG. 2C above.

Through steps 1041 to 1043, differentiated non-linear mapping processing is implemented for input texts of different lengths. When the length of the input text is higher than the preset second length threshold, the text length is relatively long. Convolution processing can capture local features in the text, so that key information in phrases and sentences can be better identified, achieving the beneficial effect of improving the accuracy of text classification.

In some embodiments, referring to FIG. 3G, before step 102 shown in FIG. 3A performs semantic enhancement processing on the input text according to the scene information of the input text and obtains the semantic enhancement result, the following steps 1023A to 1024A may also be executed, which are described in detail below.

In step 1023A, the identity prompt word of the speaker in the speech text is added to the endpoint position of the speech text in the input text. For example, identity prompt words of the plurality of speakers are added at endpoint positions of the speech text in the input text.

In some embodiments, taking two speaking objects in a customer service scenario as an example, the input text may be, for example, “Hello. Are you Zhao XX? Hello. Have you contacted Chen XX recently? I don't know Chen XX. Aren't you Zhao XX? I'm not,” and the input text after the identity prompt words corresponding to the speaking objects in the speech text are added may be, for example, “Customer: Hello. Agent: Are you Zhao XX? Customer: Hello. . . . Agent: Have you contacted Chen XX recently? Customer: I don't know Chen XX. Agent: Aren't you Zhao XX? Customer: I'm not,” and the specific implementation method of adding identity prompt words can refer to the description of step 102B1 above, which will not be repeated here.

In step 1024A, a preset separator is added between adjacent speech texts, and based on the input text with the identity prompt word and the separator, the input text is subjected to semantic enhancement processing according to the scene information of the input text. For example, separator symbols are added between adjacent speech texts of any two speaking objects, and based on the input text with the added identity prompt words and the added separator symbols, the semantic enhancement processing is performed on the input text based on the scenario information.

Continuing with the above example, the input text after the identity prompt word corresponding to the speaking object of the speech text can be, for example, “Customer: Hello. Agent: Are you Zhao XX? Customer: Hello. . . . Agent: Have you contacted Chen XX recently? Customer: I don't know Chen XX. Agent: Aren't you Zhao XX? Customer: I'm not,” and the input text with a preset separator (e.g., “[September]”) added between adjacent speech texts can be, for example, “Customer: Hello. [September] Agent: Are you Zhao XX? [September] Customer: Hello . . . [September] Agent: Have you contacted Chen XX recently? [September] Customer: I don't know Chen XX. [September] Agent: Aren't you Zhao XX? [September] Customer: I'm not.”

In some embodiments, referring to FIG. 3H, before performing semantic enhancement processing on the input text according to the scene information of the input text in step 102 shown in 3A and obtaining the semantic enhancement result, the following steps 105 to 108 may also be performed, which are described in detail below.

In step 105, the length of the input text is detected. For example, a length of the input text is detected.

In some embodiments, the length of the input text can be detected by the string processing function provided by the programming language. For example, in Python, the built-in function len( ) can be used to obtain the length of the input text; in Java, the length ( ) method of the string object can be used to obtain the length of the input text.

In step 106, when the length of the input text is greater than a preset first length threshold, feature extraction processing is performed on the input text to obtain statistical features. For example, when the length of the input text is greater than a first preset length threshold, feature extraction processing is performed on the input text to obtain statistical features.

In some embodiments, when the length of the input text is higher than a preset first length threshold (e.g., 2048 tokens) (in this case, the input text is an ultra-long conversation text), feature extraction processing is performed on the input text to obtain statistical features. For example, the term frequency (the frequency of a word appearing in the input text) and the inverse document rate (an indicator used to measure the importance of a word in the entire input text, obtained by calculating the number of text segments containing the word in the input text (e.g., a sentence is a text segment) divided by the total number of text segments and then taking the logarithm) of each word in the input text can be counted using the term frequency-inverse document frequency method (TF-IDF). The product of the term frequency of each word in the input text and the inverse document rate (reflecting the importance of each word in the input text and its contribution to the text classification task) is used as a statistical feature.

In step 107, logistic regression processing is performed on the statistical features to obtain a text classification result of the input text. For example, logistic regression processing is performed on the statistical features to obtain the text classification result.

In some embodiments, the statistical features may be standardized before performing logistic regression processing, for example, using L2 regularization (L2 Normalization) or normalization (Normalization) to reduce the differences between statistical features, and the standardized statistical features are subjected to logistic regression processing to obtain the text classification result of the input text, for example, by mapping through the Softmax function to obtain the probability distribution of each category, and the category with the highest probability value is used as the text classification result.

In step 108, when the length of the input text is less than or equal to the preset first length threshold, the step proceeds to performing semantic enhancement processing on the input text according to the scene information of the input text to obtain a semantic enhancement result. For example, when the length of the input text is less than or equal to the first preset first length threshold, the semantic enhancement processing is performed on the input text.

In some embodiments, when the length of the input text is lower than a preset first length threshold (e.g., 2048 tokens), the step of performing semantic enhancement processing on the input text according to scene information of the input text to obtain a semantic enhancement result is performed.

Here, the input text with a length that less than or equal to the first preset length threshold is semantically enhanced because the input text within this length range carries less key information, so the input text needs to be semantically enhanced to reduce the interference of text noise. For the input text greater than the preset first length threshold, text classification is performed through the implementation method of steps 106 to 107, without the need for semantic enhancement processing, thereby improving the efficiency of text classification. Through steps 105 to 108, text classification based on length-short coordination is implemented, achieving the beneficial effect of taking into account both the accuracy and efficiency of text classification.

In some embodiments, referring to FIG. 3I, before step 102 shown in FIG. 3A performs semantic enhancement processing on the input text according to the scene information of the input text and obtains the semantic enhancement result, the following steps 109 to 110 may also be executed, which are described in detail below.

In step 109, feature information of multiple speaking objects is obtained, and text conversion is performed on the feature information to obtain converted text. For example, speech from the plurality of speakers is obtained. Text conversion processing is performed on the speech to obtain converted text.

In some embodiments, feature information of multiple speaking objects (e.g., feature information of speaking objects included in call data, etc.) is obtained, and text conversion processing is performed on the feature information to obtain converted text. For example, for discrete feature information, label encoding can be used to convert it into text form (converted text). For example, for gender features, 0 represents male and 1 represents female, and the gender label corresponding to the numerical value can be replaced with text. According to specific business needs, the mapping relationship between feature information and corresponding text can be customized. For example, for income features, different income levels (low, medium, high) can be defined and mapped to text labels to obtain converted text. For example, feature information can include: 1) numerical (e.g., age, amount, etc.) or discrete features (e.g., gender, education, etc.); 2) results of other model outputs (e.g., in the output results of the emotion recognition model, 0 represents “neutral” emotion, 1 represents “angry” emotion, 2 represents “happy” emotion, etc., and a dictionary or mapping table can be created to convert the emotion category corresponding to each number into a text representation to obtain the converted text).

In step 110, the converted text is added to the input text. For example, the input text is generated based on the converted text.

Continuing with the above example, in the customer service scenario, the converted text obtained after converting the numerical or discrete features is added to the input text, which can be represented by Table 3:

TABLE 3

| Enter text | Example of adding converted text to input text |
|---|---|
| Hello. Hello. Are you Mr. Zhao XX? . . . | [Colleague] Hello. Hello. Are you Mr. Zhao XX? . . . |
| Hello. Hello. Are you Mr. Wang XX? . . . | [Friend] Hello. Hello. Are you Mr. Wang XX? . . . |
| Hello. Hello. Are you Mr. Chen XX? . . . | [Myself] Hello. Hello. Are you Mr. Chen XX? . . . |

Referring to Table 3, the text corresponding to the relationship type between the inquiry object in the text (e.g., “Mr. Zhao XX,” “Mr. Wang XX” and other contacts in Table 3) and the borrower (e.g., “colleague,” “friend” and so on in Table 3) is added to the input text. Among them, “colleague,” “friend” and “myself” are converted from the relationship types “TPC,” “RPC” and “SELF” (the corresponding feature information is subjected to text conversion processing to obtain the converted text). The relationship type comes from the communication data, and the conversion method is to replace the text based on the relationship type.

Continuing with the above example, in the customer service scenario, the converted text obtained by converting the output of other models is added to the input text, which can be represented by Table 4:

TABLE 4

| Enter text | Example of adding converted text to input text |
|---|---|
| Are you XXX? Yes. You have a loan of 3,000 | [Say the amount] Are you XXX? Yes. You have a |
| yuan. . . . | loan of 3,000 yuan. . . . |
| Are you XXX? Yes. You have a loan of 3,000 | [Say the amount, myself] Are you XXX? Yes. You |
| yuan. . . . | have a loan of 3,000 yuan. . . . |

In Table 4, “say the amount” is transformed from the result of regular model recognition. The regular model can use regular expression patterns to match and extract specific patterns or rules in the text. For example, the amount can be identified to determine whether the feature information is “say the amount.” If the text can match the regular expression form of the amount, it can be determined as “say the amount.” For example, the regular expression can be “(one |two |three |four |five |six |seven |eight |nine |ten |thousand |ten thousand) hundred (one |two |three |four |five |six |seven |eight |nine |ten) | (one |two |three |four |five |six |seven |eight |nine |ten |ten thousand) thousand (one |two |three |four |five |six |seven |eight |nine |ten |hundred) | (one |two |three |four |five |six |seven |eight |nine |ten) ten thousand (one |two |three |four |five |six |seven |eight |nine |ten |hundred |ten thousand),” here, the converted text corresponding to the relationship type in Table 3 can also be synchronously added to the input text (corresponding to “Say the amount, myself” in Table 4).

Through steps 101 to 110, differentiated processing of input texts of different lengths is achieved, and targeted semantic enhancement processing is performed according to the length of the input text and the corresponding scene information. The text classification scheme of input texts of different lengths is taken into consideration, so that the semantic enhancement processing can be differentiated according to different text lengths and scene information, thereby improving the representation ability of the semantic enhancement result for the input text, and then encoding processing is performed based on the obtained semantic enhancement result to obtain text encoding, and then the text classification result of the input text is obtained based on the text encoding, thereby achieving the beneficial effect of improving the accuracy of text classification.

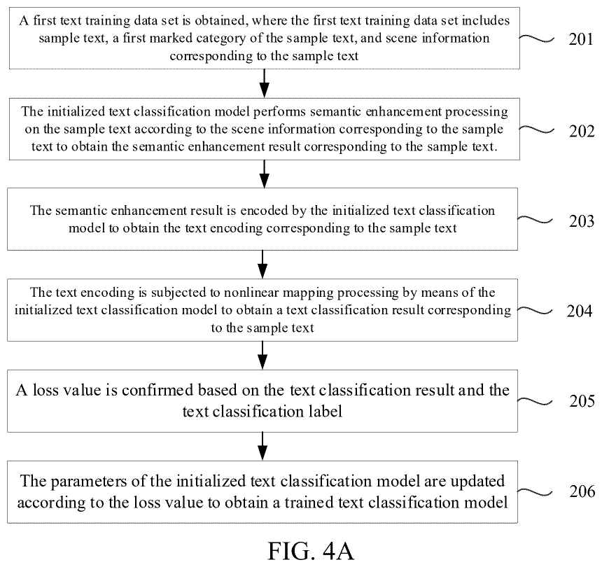

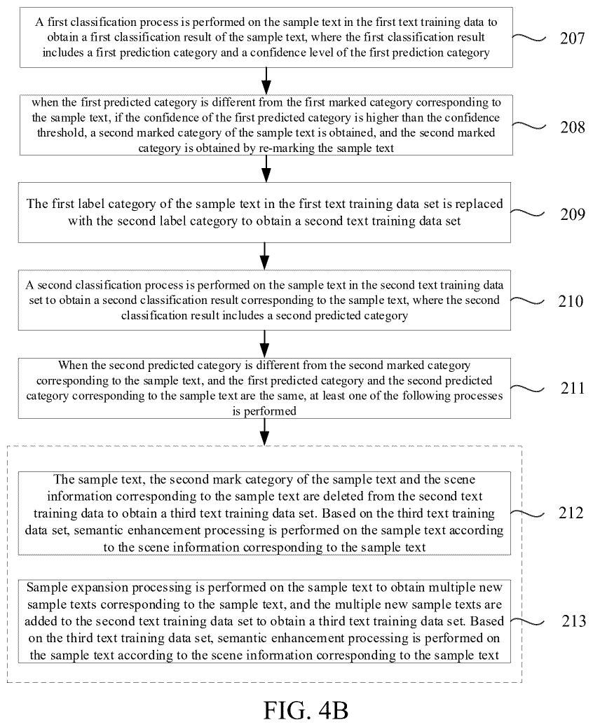

An example implementation of the server provided in the embodiment of the present disclosure, with the server as the execution subject, is described below to illustrate the training method of the text classification model provided in the embodiment of the present disclosure. FIG. 4A is a first flow chart of a training method of a text classification model provided in an embodiment of the present disclosure, which will be explained in combination with the steps shown in FIG. 4A.

In step 201, a first text training data set is obtained, where the first text training data set includes sample text, a first marked category of the sample text, and scene information corresponding to the sample text. For example, a first training dataset including a sample text, a first category label corresponding to the sample text, and scenario information corresponding to the sample text is obtained.

In some embodiments, the first text training data includes sample text, a first labeled category of the sample text, and scene information corresponding to each sample text. For example, the first text data set can be represented as {[sample text 1: “Hello. Are you Zhao XX? Hello. . . . Have you contacted Chen XX recently? I don't know Chen XX. Aren't you Zhao XX? I'm not.”; first labeled category: the party answering the phone does not know the customer; scene information: determine the relationship between the party answering the phone and the customer], [sample text 2: “Hello. Hello. Are you Mr. Chen XX? . . . ”; first labeled category: the party answering the phone is not the customer himself; scene information: determine whether the party answering the phone is the customer himself] . . . }.

In step 202, the initialized text classification model performs semantic enhancement processing on the sample text according to the scene information corresponding to the sample text to obtain the semantic enhancement result corresponding to the sample text. For example, semantic enhancement processing is performed via an initialized text classification model on the sample text based on the corresponding scenario information to obtain a semantic enhancement result.

In some embodiments, the sample text is semantically enhanced according to the scene information corresponding to the sample text through the initialized text classification model. For example implementation method for obtaining the semantic enhancement result corresponding to the sample text, reference can be made to the description of step 102 above and will not be repeated here.

In step 203, the semantic enhancement result is encoded by the initialized text classification model to obtain the text encoding corresponding to the sample text. For example, the semantic enhancement result is encoded through the initialized text classification model to obtain a text encoding corresponding to the sample text.

In some embodiments, the semantic enhancement result is encoded by the initialized text classification model to obtain the text encoding corresponding to the sample text. The implementation method can refer to the description of step 103 above and will not be repeated here.

In step 204, the text encoding is subjected to non-linear mapping processing by means of the initialized text classification model to obtain a text classification result corresponding to the sample text. For example, non-linear mapping processing is performed via the initialized text classification model on the text encoding to obtain a text classification result corresponding to the sample text.

In some embodiments, the implementation method of performing non-linear mapping processing on the text encoding through the initialized text classification model to obtain the text classification result corresponding to the sample text can be based on the description of step 104 above, which will not be repeated here.

In step 205, a loss value is confirmed based on the text classification result and the text classification label. For example, a loss value is calculated based on the text classification result and the first category label.

In some embodiments, the loss value is confirmed based on the text classification result and the text classification label through a preset loss function (e.g., a cross entropy loss function).

In step 206, the parameters of the initialized text classification model are updated according to the loss value to obtain a trained text classification model. For example, parameters of the initialized text classification model are updated based on the loss value to obtain a trained text classification model.

In some embodiments, the gradient of the loss function is calculated by back propagation and optimization algorithms (e.g., Adam, SGD, AdamW, etc.), and the parameters of the abnormal object recognition model (e.g., the weight matrix of the dense layer in formula (1) and the bias term and other model parameters) are updated according to the gradient direction to minimize the loss value of the loss function, thereby obtaining a trained text classification model.

Through steps 201 to 206, semantic enhancement processing is performed on the input text according to the scene information of the input text, so that the semantic enhancement processing can be adjusted differently according to different scene information. The representation ability of the semantic enhancement result for the input text can be improved, and the text classification model can be trained to learn to perform semantic enhancement processing on input texts of different lengths according to the corresponding scene information, thereby achieving the beneficial effect of improving the performance and generalization ability of the text classification model.

FIG. 6B is a flow chart of training and prediction of a text classification model provided in an embodiment of the present disclosure. After obtaining a first text training data set, a two-stage optimization process of the first text training data set can be performed (corresponding to steps 207 to 213 below), and then the feature information of the speaking object is integrated into the sample text (corresponding to steps 109 to 110 above, where the sample text corresponds to the input text above). Next, the sample text is subjected to long-short collaborative semantic enhancement based on scene information (corresponding to the description of step 202 above), thereby training a text classification model and performing a text classification task based on the trained text classification model.

In some embodiments, the sample text may be a text converted from a relatively long whole conversation. Since the whole conversation contains certain logic, the complexity of the annotation work is relatively high, and annotation errors are more likely to occur (i.e., the first tag category of the sample text in the first text training data set is wrong). See FIG. 6A, which is a flow chart of the principle of removing label noise provided in an embodiment of the present disclosure. After obtaining the sample text, the sample text can be annotated by manual marking (corresponding to the first tag category). After marking, the first tag category is verified by a preset algorithm (e.g., a support vector machine) (corresponding to step 207 below). When the algorithm verification fails (i.e., the algorithm prediction result is different from the first tag category, corresponding to step 208 below), the sample text is manually marked for the second time (corresponding to step 209 below), and then the algorithm verification and quality inspection are re-performed (corresponding to step 210 below). According to the quality inspection results, the sample text is deleted or the sample is expanded (corresponding to steps 211 to 213 below) until the verification is successful (i.e., the result predicted by the algorithm is the same as the first tag category).

Referring to FIG. 4B, after obtaining the first text training data set, the following steps 207 to 213 may also be performed, which are described in detail below.

In step 207, a first classification process is performed on the sample text in the first text training data to obtain a first classification result of the sample text, where the first classification result includes a first prediction category and a confidence level of the first prediction category. For example, a first classification processing is performed on the sample text in the first training dataset to obtain a first classification result of the sample text. In an example, each first classification result includes a first prediction category and a confidence score of the first prediction category.

In some embodiments, a first classification process is performed on the sample text in the first text training data through a preset classification method (e.g., a support vector machine (SVM)) (corresponding to the algorithm verification in FIG. 6A) to obtain a first classification result for each sample text. The first classification result includes a first prediction category and a confidence level of the first prediction category. Here, confidence is an indicator for measuring the reliability of a prediction result. In a classification task, confidence reflects the model's confidence level in a certain prediction result, that is, the model believes that the probability that the prediction result is a correct classification.

In other embodiments, all sample texts may be subjected to a first classification process by means of K-fold cross validation, and sample texts predicted incorrectly by the model may be sorted according to the degree of confidence.

In step 208, when the first predicted category is different from the first marked category corresponding to the sample text, if the confidence of the first predicted category is higher than the confidence threshold, a second marked category of the sample text is obtained, and the second marked category is obtained by re-marking the sample text. For example, when the first prediction category is different from the first category label and has the confidence score exceeding a confidence threshold, a second category label is obtained through re-annotation of the corresponding sample text.

In some embodiments, when the first predicted category is different from the first marked category corresponding to the sample text (corresponding to the verification failure in FIG. 6A), if the confidence of the first predicted category is higher than the confidence threshold (e.g., the confidence threshold is 0.8), the second marked category of the sample text is obtained, and the second marked category is obtained by re-annotating the sample text (e.g., the second marked category is obtained by manual annotation).

In step 209, the first label category of the sample text in the first text training data set is replaced with the second label category to obtain a second text training data set. For example, the first category label is replaced with the second category label in the first training dataset to obtain a second training dataset.

In some embodiments, the second label category replaces the first label category in the original first text training data set to obtain the second text training data set.

In step 210, a second classification process is performed on the sample text in the second text training data set to obtain a second classification result corresponding to the sample text, where the second classification result includes a second predicted category. For example, second classification processing is performed on the sample text in the second training dataset to obtain a second classification result. In an example, each second classification result includes a second prediction category.

In some embodiments, the specific implementation of the second classification process can refer to the description of step 207 above, which will not be repeated here.

In step 211, when the second predicted category is different from the second marked category corresponding to the sample text, and the first predicted category and the second predicted category corresponding to the sample text are the same, at least one of the following processes is performed.

In some embodiments, sample text that has undergone two classification processes and has the same classification result both times and has failed algorithm verification is subjected to the “quality check” in FIG. 6A.

In step 212, the sample text, the second mark category of the sample text and the scene information corresponding to the sample text are deleted from the second text training data to obtain a third text training data set. Based on the third text training data set, semantic enhancement processing is performed on the sample text according to the scene information corresponding to the sample text. For example, the sample text, the second category label of the sample text, and the scenario information corresponding to the sample text from the second training dataset are removed to obtain a third training dataset, and the semantic enhancement processing is performed using the third training dataset.

In some embodiments, when the sample text itself contains a large amount of text information and the content is relatively complex, such as an extremely long text (e.g., a text with a length of 2048 tokens or more), the text classification model is difficult to learn. The processing method for this type of sample text is to delete it to obtain a third text training data set.

In step 213, sample expansion processing is performed on the sample text to obtain multiple new sample texts corresponding to the sample text, and the multiple new sample texts are added to the second text training data set to obtain a third text training data set. Based on the third text training data set, semantic enhancement processing is performed on the sample text according to the scene information corresponding to the sample text. For example, sample augmentation processing is performed on the sample text to obtain multiple new sample texts, the multiple new sample texts are added to the second training dataset to obtain the third training dataset, and the semantic enhancement processing is performed using the third training dataset.

In some embodiments, when similar sample texts are missing in the second text training data set, resulting in insufficient learning of the text classification model, a “sample expansion” method, such as Exploratory Data Analysis (EDA) and other methods, is used for such sample texts to expand similar expressions and obtain multiple new sample texts corresponding to the sample texts. The multiple new sample texts are added to the second text training data set to obtain a third text training data set. The algorithm can be re-verified and iterated N times to continuously reduce the number of sample texts that fail verification.

Through steps 207 to 213, in the pre-training stage, the two-stage optimization processing of the first text training data set (corresponding to the first classification processing and the second classification processing mentioned above) is implemented to remove the incorrectly labeled categories in the first text training data set or the negative sample texts that are difficult for the model to learn. Accordingly, the beneficial effect of reducing the influence of the labeling errors or negative sample texts on the training of the text classification model can be better achieved, thereby improving the performance of the text classification model.

The text classification method or text classification model training method provided in the embodiments of the present disclosure can be applied to various scenarios that require text classification, some of which include: (1) sentiment analysis, such as analyzing consumers' comments on products or services and classifying them into positive, negative or neutral sentiments; (2) product review classification, such as analyzing product reviews and classifying them into different evaluation levels, such as good reviews, medium reviews, bad reviews, etc.; (3) customer service, such as analyzing customer service requests or obtaining customer intent and classifying them into different topics or intent types; (4) search engine optimization, such as optimizing search engine results and classifying search results into more relevant categories through classification technology, etc.

In customer service scenarios, the distribution of call text length varies dramatically under different circumstances. Text lengths of 10-10,000 tokens are possible, depending mainly on the scenario information. However, it does not mean that a short call text contains less information and the sample importance is low; or that a long call text contains more information and the sample importance is high. For example, in a financial scenario, when identifying a call text corresponding to the scenario information “whether the lender has been contacted,” the conversation is often shorter, while when identifying a call text corresponding to the scenario information “denying the loan,” the conversation is longer because the customer generally explains why there is no loan, as shown in Table 5 below:

TABLE 5

| Scene Information | Call text example |
|---|---|
| Have you contacted the lender? | Customer: Hello. Agent: Excuse me, are you Zhao |
| | XX? Customer: No, It's a wrong number. |
| Denial of loan | Agent: Hello. Agent: Hello, this is partner XX. |
| | Agent: Are you Mr. Zhang XX? Customer: Yes. |
| | Agent: Your Anyihua loan is overdue. The amount |
| | owed is 336.26 yuan. Agent: Can you pay it back |
| | through the APP today? Customer: What platform |
| | are you using? . . . Customer: I don't remember that |
| | I have taken out a loan. Agent: The APP shows that |
| | there was a repayment record last month. . . . |

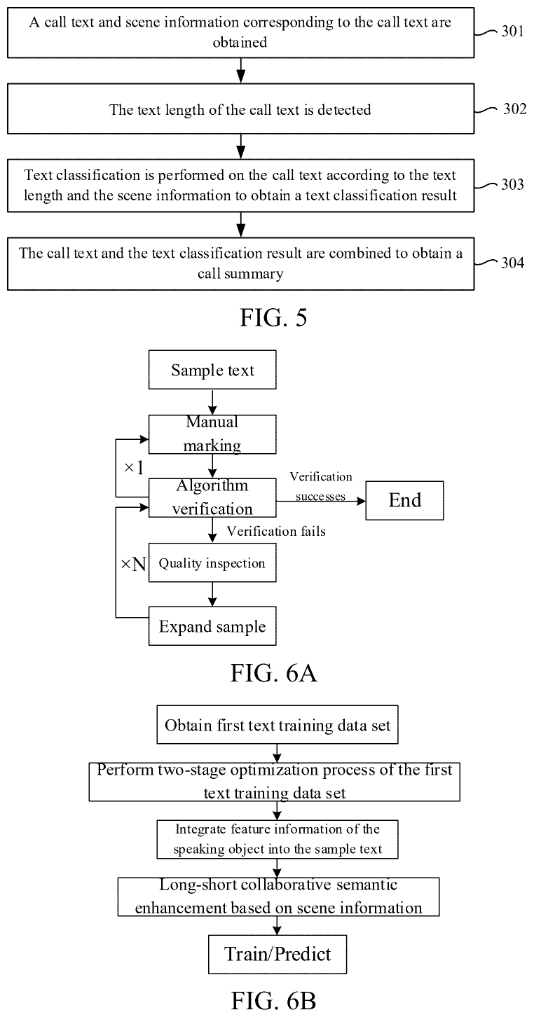

Therefore, differentiated text classification processing can be performed according to the length of the text and the corresponding scene information, so as to obtain a more accurate text classification result. The following is an example disclosure of the embodiment of the present disclosure in a customer service scenario related to the lending business. See FIG. 5, which is a flow chart of the text classification method in the customer service scenario provided by the embodiment of the present disclosure, which is described in detail below.

In step 301, a call text and scene information corresponding to the call text are obtained.

In some embodiments, call data in audio form can be converted into call text (corresponding to the input text above) through automatic speech recognition technology, and corresponding scenario information can be obtained based on the specific business scenario in the call. For example, in a business scenario, when the purpose of the call is for the agent (the caller) to convey business information related to the loan borrower through the contact person (the answering party), the corresponding scenario information can be used to determine the situation of the answering party conveying the information.

In step 302, the text length of the call text is detected.

In some embodiments, the length of the call text can be detected by the string processing function provided by the programming language. For example, in Python, the built-in function len( ) can be used to obtain the length of the call text; in Java, the length( ) method of the string object can be used to obtain the length of the call text.

In step 303, text classification is performed on the call text according to the text length and the scene information to obtain a text classification result.

In some embodiments, when the text length is less than or equal to 512 tokens, the call text is a regular conversation text, and semantic enhancement processing is performed on the call text according to the scene information of the call text to obtain a semantic enhancement result; the semantic enhancement result is encoded to obtain a text encoding; the text encoding is non-linearly mapped to obtain a text classification result of the call text. The specific implementation method of semantically enhancing the call text according to the scene information of the call text to obtain the semantic enhancement result can be found in the description of steps 102A1 to 102A2 above. The specific implementation method of encoding the semantic enhancement result to obtain the text encoding can be found in the description of steps 1031 to 1033 above. The specific implementation method of performing non-linear mapping processing on the text encoding to obtain the text classification result of the call text can be found in the description of step 1041 above, which will not be repeated here.

In some embodiments, when the text length is greater than 512 tokens and less than or equal to 2048 tokens, the call text is a medium-length conversation text, and semantic enhancement processing is performed on the call text according to the scene information of the call text to obtain a semantic enhancement result. The semantic enhancement result is encoded to obtain a text encoding. The text encoding is non-linearly mapped to obtain a text classification result of the call text. The specific implementation method of semantically enhancing the call text according to the scene information of the call text to obtain the semantic enhancement result can be based on the description of steps 102B1 to 102B3 above. The specific implementation method of encoding the semantic enhancement result to obtain the text encoding can be based on the description of formula (5) above. The specific implementation method of non-linearly mapping the text encoding to obtain the text classification result of the call text can be based on the description of steps 1042 to 1043 above, which will not be repeated here.

In some embodiments, when the text length is greater than 2048 tokens, the call text is an ultra-long conversation text, and feature extraction processing is performed on the call text to obtain statistical features, and logistic regression processing is performed on the statistical features to obtain text classification results of the input text. The specific implementation method can be based on the description of steps 106 to 107 above, which will not be repeated here.

In step 304, the call text and the text classification result are combined to obtain a call summary.

In some embodiments, the call text and text classification results are combined to obtain a call summary, thereby helping customer service personnel to better understand customer needs, problems, and feedback, and respond and handle them more effectively.

Through steps 301 to 304, differentiated processing of call texts of different lengths is achieved, and targeted semantic enhancement processing is performed according to the length of the call text and the corresponding scene information. The text classification schemes of call texts of different lengths are considered, so that the semantic enhancement processing can be differentiated according to different text lengths and scene information, thereby improving the representation ability of the semantic enhancement results for the call texts, and then encoding processing is performed based on the obtained semantic enhancement results to obtain text encoding, and then the text classification results of the call text are obtained based on the text encoding, so that customer service personnel can obtain more accurate call summaries, so as to better understand customer needs, problems and feedback, respond and process more effectively, thereby improving customer satisfaction with customer service.

The following is a description of an example of a structure of the text classification device 133 provided in the embodiment of the present disclosure implemented as a software module. In some embodiments, as shown in FIG. 2A, the software module stored in the text classification device 133 of the memory 130 may include a data acquisition module 1331, an enhancement module 1332, an encoding module 1333, and a classification module 1334.

The data acquisition module 1331 is used to acquire input text and scene information corresponding to the input text.

The enhancement module 1332 is used to perform semantic enhancement processing on the input text according to the scene information of the input text to obtain a semantic enhancement result.

The encoding module 1333 is used to encode the semantic enhancement result to obtain text encoding.

The classification module 1334 is used to perform non-linear mapping processing on the text encoding to obtain a text classification result of the input text.

In some embodiments, the enhancement module 1332 is also used to perform vectorization processing on the input text to obtain a vectorization result of the input text; and perform semantic enhancement processing on the vectorization result according to a semantic enhancement method corresponding to the scene information to obtain a semantic enhancement result, and one type of scene information corresponds to one type of semantic enhancement method.

In some embodiments, the input text includes speech texts corresponding to multiple speech objects, and the enhancement module 1332 is further used to set the sentence identifier corresponding to the key text in the vectorization result to a first preset value to obtain a first semantic enhancement result when the pre-configuration information of the scene information indicates that the input text includes key text; and to set the sentence identifier corresponding to the speech text in the input text to a second preset value to obtain a second semantic enhancement result when the pre-configuration information of the scene information indicates that the input text does not include key text, and the speech text of one speech object corresponds to one second preset value.

In some embodiments, the enhancement module 1332 is further used to add an identity prompt word of the speaking object of the speech text at the endpoint position of the speech text in the input text; add a preset separator symbol between any two adjacent speech texts of the speaking objects, and based on the input text with the identity prompt word and the separator symbol added, enter the step of performing semantic enhancement processing on the input text according to the scene information of the input text.

In some embodiments, the encoding module 1333 is also used to perform embedded encoding processing on the semantic enhancement result to obtain an embedded encoding result; perform attention encoding processing on the embedded encoding result to obtain an attention encoding result; perform non-linear mapping processing on the attention encoding result to obtain the text encoding.

In some embodiments, the enhancement module 1332 is further used to add an identity prompt word of the speaking object of the speech text to the endpoint position of the speech text in the input text; when the pre-configuration information of the scene information indicates that the input text includes a key text, if the key text includes speech texts of multiple speaking objects, a preset marking symbol is added between the adjacent speech texts of any two speaking objects, and the input text with the identity prompt word and the marking symbol added is used as a third semantic enhancement result; when the pre-configuration information of the scene information indicates that the input text does not include a key text, the preset marking symbol is added between the adjacent speech texts of any two speaking objects, and the input text with the identity prompt word and the marking symbol added is used as a fourth semantic enhancement result.

In some embodiments, the classification module 1334 is also used to detect the length of the input text; when the length of the input text is greater than a preset first length threshold, feature extraction processing is performed on the input text to obtain statistical features; logistic regression processing is performed on the statistical features to obtain a text classification result of the input text; when the length of the input text is less than or equal to the preset first length threshold, the step of performing semantic enhancement processing on the input text according to the scene information of the input text to obtain a semantic enhancement result is performed.

In some embodiments, the preset second length threshold is smaller than the preset first length threshold, and the classification module 1334 is further used to, when the length of the input text is smaller than or equal to the preset second length threshold, perform a first non-linear mapping process on the text encoding to obtain a first probability value for each category, and determine the result of the text classification based on the first probability value; when the length of the input text is greater than the preset second length threshold and smaller than or equal to the preset first length threshold, perform a convolution process on the text encoding to obtain a convolution feature; perform a second non-linear mapping process on the convolution feature to obtain a second probability value for each category, and determine the result of the text classification based on the second probability value.

In some embodiments, the input text corresponds to multiple speaking objects, and the data acquisition module 1331 is further used to obtain feature information of the multiple speaking objects, and perform text conversion processing on the feature information to obtain converted text; and add the converted text to the input text.

The following continues to describe an example of a structure of the text classification model training device 134 provided in the embodiment of the present disclosure implemented as a software module. In some embodiments, as shown in FIG. 2B, the software module stored in the text classification model training device 134 in the memory 130-2 may include a data acquisition module 1341 and a training module 1342.

The data acquisition module 1341 is used to acquire a first text training data set, where the first text training data includes a sample text, a first tag category of the sample text, and scene information corresponding to the sample text.

The training module 1342 is used to perform semantic enhancement processing on the sample text according to the scene information corresponding to the sample text through the initialized text classification model, so as to obtain the semantic enhancement result corresponding to the sample text.

In some embodiments, the training module 1342 is further used to encode the semantic enhancement result through the initialized text classification model to obtain the text encoding corresponding to the sample text.

In some embodiments, the training module 1342 is further used to perform non-linear mapping processing on the text encoding through the initialized text classification model to obtain a text classification result corresponding to the sample text.

In some embodiments, the training module 1342 is further used to confirm a loss value based on the text classification result and the text classification label.

In some embodiments, the training module 1342 is further used to update the parameters of the initialized text classification model according to the loss value to obtain a trained text classification model.

In some embodiments, the data acquisition module 1341 is further used to perform a first classification process on the sample text in the first text training data to obtain a first classification result of the sample text. The first classification result includes a first prediction category and a confidence level of the first prediction category. In a case where the first prediction category is different from a first label category corresponding to the sample text, if the confidence level of the first prediction category is higher than a confidence threshold, the data acquisition module 1341 is configured to obtain a second label category of the sample text. The second label category is obtained by re-labeling the sample text. The data acquisition module 1341 is configured to replace the first label category of the sample text in the first text training data set with the second label category to obtain a second text training data set. The data acquisition module 1341 is configured to perform a second classification process on the sample text in the second text training data set to obtain a second classification result corresponding to the sample text. The second classification result includes a second prediction category. When the second prediction category is different from the second mark category corresponding to the sample text, and the first prediction category and the second prediction category corresponding to the sample text are the same, the data acquisition module 1341 is configured to perform at least one of the following processing: delete the sample text, the second mark category of the sample text and the scene information corresponding to the sample text from the second text training data to obtain a third text training data set, and based on the third text training data set, proceed to execute the semantic enhancement processing of the sample text according to the scene information corresponding to the sample text; perform sample expansion processing on the sample text to obtain multiple new sample texts corresponding to the sample text, add the multiple new sample texts to the second text training data set to obtain a third text training data set, and based on the third text training data set, proceed to execute the semantic enhancement processing of the sample text according to the scene information corresponding to the sample text.

The embodiment of the present disclosure provides a computer program product, which includes a computer program or a computer executable instruction, and the computer program or the computer executable instruction is stored in a computer-readable storage medium. The processor of the electronic device reads the computer executable instruction from the computer-readable storage medium, and the processor executes the computer executable instruction, so that the electronic device executes the text classification method described above in the embodiment of the present disclosure or the training method of the text classification model provided in the embodiment of the present disclosure.

An embodiment of the present disclosure provides a computer-readable storage medium such as a non-transitory computer-readable storage medium storing computer-executable instructions, in which computer-executable instructions or computer programs are stored. When the computer-executable instructions or computer programs are executed by a processor, the processor will be caused to execute any of the above-described text classification methods or training methods of the text classification model, such as, the text classification method shown in FIG. 3A or the training method of the text classification model shown in FIG. 4A.

In some embodiments, the computer-readable storage medium may be a memory such as RAM, ROM, flash memory, magnetic surface memory, optical disk, or CD-ROM; or may be various devices including one or any combination of the above memories.

In some embodiments, computer executable instructions may be in the form of a program, software, software module, script or code, written in any form of programming language (including compiled or interpreted languages, or declarative or procedural languages), and may be deployed in any form, including as a stand-alone program or as a module, component, subroutine or other unit suitable for use in a computing environment.

As an example, computer-executable instructions may, but need not, correspond to a file in a file system, may be stored as part of a file storing other programs or data, such as in one or more scripts in a HyperText Markup Language (HTML) document, in a single file dedicated to the program in question, or in multiple coordinated files (e.g., files storing one or more modules, subroutines, or code portions).

As an example, computer executable instructions may be deployed to be executed on one electronic device, or on multiple electronic devices located at one site, or on multiple electronic devices distributed at multiple sites and interconnected by a communication network.

To summarize, through the embodiments of the present disclosure, according to the scene information of the input text, the input text is semantically enhanced in a manner adaptive to the scene information. Compared with the related art method of simply classifying based on the text encoding of the input text, the text encoding obtained based on the semantic enhancement processing can fully represent the semantics of the input text in various scenarios, overcome the influence of noise in the input text, and thereby improve the accuracy of the text classification results obtained by non-linear mapping based on the text encoding.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The above is only an example embodiment of the present disclosure and is not intended to limit the protection scope of the present disclosure. Any modifications, equivalent replacements and improvements made within the spirit and scope of the present disclosure are included in the protection scope of the present disclosure.

What is claimed is:

1. A method for text classification, the method comprising:
receiving an input text and scenario information corresponding to the input text;
performing, by processing circuitry, semantic enhancement processing on the input text based on the scenario information to obtain a semantic enhancement result;
encoding the semantic enhancement result to obtain a text encoding; and
applying non-linear mapping processing on the text encoding to obtain a text classification result of the input text.

2. The method according to claim 1, wherein the scenario information indicates a purpose of a conversation between a plurality of speakers from which the input text is generated.

3. The method according to claim 1, wherein the performing the semantic enhancement processing comprises:
performing vectorization processing on the input text to obtain a vectorization result of the input text; and
performing the semantic enhancement processing on the vectorization result based on which of a plurality of semantic enhancements is determined to correspond to the scenario information to obtain the semantic enhancement result, each of the plurality of semantic enhancements being associated with a different type of scenario information.

4. The method according to claim 3, wherein
the input text includes speech text of a plurality of speakers, and
the performing the semantic enhancement processing on the vectorization result comprises:
when pre-configured information of the scenario information indicates the input text includes key text, setting a sentence identifier corresponding to the key text in the vectorization result with a first type of identifier to obtain a first semantic enhancement result; and
when pre-configuration information of the scenario information indicates the input text does not include the key text, setting the sentence identifier corresponding to the speech text in the input text with a second type of identifier to obtain a second semantic enhancement result, wherein the plurality of speakers are associated with different values of the second type of identifier.

5. The method according to claim 4, further comprising:
adding identity prompt words of the plurality of speakers at endpoint positions of the speech text in the input text;
adding separator symbols between adjacent speech texts of any two speaking objects; and
based on the input text with the added identity prompt words and the added separator symbols, performing the semantic enhancement processing on the input text based on the scenario information.

6. The method according to claim 1, wherein the encoding comprises:
performing embedded encoding on the semantic enhancement result to obtain an embedded encoding result;
performing attention encoding processing on the embedded encoding result to obtain an attention encoding result; and
performing the non-linear mapping processing on the attention encoding result to obtain the text encoding.

7. The method according to claim 1, wherein the performing the semantic enhancement processing on the input text comprises:
adding identity prompt words of a plurality of speakers at endpoint positions of speech text in the input text;
when pre-configuration information of the scenario information indicates the input text includes key text, and the key text includes the speech text of multiple speakers, adding marker symbols between adjacent speech texts of any two speaker, and using the input text with the added identity prompt words and the added marker symbols as a third semantic enhancement result; and
when the pre-configuration information of the scenario information indicates the input text does not include the key text, adding the marker symbols between the adjacent speech texts of any two speakers, and using the input text with the added identity prompt words and the added marker symbols as a fourth semantic enhancement result.

8. The method according to claim 1, further comprising:
detecting a length of the input text;
when the length of the input text is greater than a first preset length threshold, performing feature extraction processing on the input text to obtain statistical features, performing logistic regression processing on the statistical features to obtain the text classification result; and
when the length of the input text is less than or equal to the first preset first length threshold, performing the semantic enhancement processing on the input text.

9. The method according to claim 8, wherein
a second preset length threshold is less than the first preset length threshold, and
the performing the non-linear mapping processing on the text encoding to obtain the text classification result comprises:
when the length of the input text is less than or equal to the second preset length threshold,
performing first non-linear mapping processing on the text encoding to obtain a first probability value for each classification category, and
determining the text classification result based on the first probability value; and
when the length of the input text is greater than the second preset length threshold and less than or equal to the first preset length threshold,
performing convolution processing on the text encoding to obtain a convolution feature, and
performing second non-linear mapping processing on the convolution feature to obtain a second probability value for each classification category, and determining the text classification result based on the second probability value.

10. The method according to claim 1, wherein the input text includes speech text from a plurality of speakers, and the method further comprises:
obtaining speech from the plurality of speakers;
performing text conversion processing on the speech to obtain converted text; and
generating the input text based on the converted text.

11. A method for training a text classification model, the method comprising:
obtaining a first training dataset including a sample text, a first category label corresponding to the sample text, and scenario information corresponding to the sample text;
performing, via an initialized text classification model, semantic enhancement processing on the sample text based on the corresponding scenario information to obtain a semantic enhancement result;
encoding, via the initialized text classification model, the semantic enhancement result through the initialized text classification model to obtain a text encoding corresponding to the sample text; and
performing, via the initialized text classification model, non-linear mapping processing on the text encoding to obtain a text classification result corresponding to the sample text;
calculating a loss value based on the text classification result and the first category label; and
updating parameters of the initialized text classification model based on the loss value to obtain a trained text classification model.

12. The method according to claim 11, further comprising:
performing a first classification processing on the sample text in the first training dataset to obtain a first classification result of the sample text, wherein each first classification result includes a first prediction category and a confidence score of the first prediction category;
when the first prediction category is different from the first category label and has the confidence score exceeding a confidence threshold, obtaining a second category label through re-annotation of the corresponding sample text;
replacing the first category label with the second category label in the first training dataset to obtain a second training dataset;
performing second classification processing on the sample text in the second training dataset to obtain a second classification result, wherein each second classification result includes a second prediction category;
when the second prediction category is different from the corresponding second category label and matches the first predicted category for the sample text, performing at least one of:
removing the sample text, the second category label of the sample text, and the scenario information corresponding to the sample text from the second training dataset to obtain a third training dataset, and performing the semantic enhancement processing using the third training dataset; or
performing sample augmentation processing on the sample text to obtain multiple new sample texts, adding the multiple new sample texts to the second training dataset to obtain the third training dataset, and performing the semantic enhancement processing using the third training dataset.

13. An apparatus, comprising:
processing circuitry configured to:
receive an input text and scenario information corresponding to the input text;
perform semantic enhancement processing on the input text based on the scenario information to obtain a semantic enhancement result;
encode the semantic enhancement result to obtain a text encoding; and
apply non-linear mapping processing on the text encoding to obtain a text classification result of the input text.

14. The apparatus according to claim 13, wherein the scenario information indicates a purpose of a conversation between a plurality of speakers from which the input text is generated.

15. The apparatus according to claim 13, wherein the processing circuitry is configured to:
perform vectorization processing on the input text to obtain a vectorization result of the input text; and
perform the semantic enhancement processing on the vectorization result based on which of a plurality of semantic enhancements is determined to correspond to the scenario information to obtain the semantic enhancement result, each of the plurality of semantic enhancements being associated with a different type of scenario information.

16. The apparatus according to claim 15, wherein the input text includes speech text of a plurality of speakers, and the processing circuitry is configured to:
when pre-configured information of the scenario information indicates the input text includes key text, set a sentence identifier corresponding to the key text in the vectorization result with a first type of identifier to obtain a first semantic enhancement result; and
when pre-configuration information of the scenario information indicates the input text does not include the key text, set the sentence identifier corresponding to the speech text in the input text with a second type of identifier to obtain a second semantic enhancement result, wherein the plurality of speakers are associated with different values of the second type of identifier.

17. The apparatus according to claim 16, wherein the processing circuitry is configured to:
add identity prompt words of the plurality of speakers at endpoint positions of the speech text in the input text;
add separator symbols between adjacent speech texts of any two speaking objects; and
based on the input text with the added identity prompt words and the added separator symbols, perform the semantic enhancement processing on the input text based on the scenario information.

18. The apparatus according to claim 13, wherein the processing circuitry is configured to:
perform embedded encoding on the semantic enhancement result to obtain an embedded encoding result;
perform attention encoding processing on the embedded encoding result to obtain an attention encoding result; and
perform the non-linear mapping processing on the attention encoding result to obtain the text encoding.

19. The apparatus according to claim 13, wherein the processing circuitry is configured to:
add identity prompt words of a plurality of speakers at endpoint positions of speech text in the input text;
when pre-configuration information of the scenario information indicates the input text includes key text, and the key text includes the speech text of multiple speakers, add marker symbols between adjacent speech texts of any two speaker, and use the input text with the added identity prompt words and the added marker symbols as a third semantic enhancement result; and
when the pre-configuration information of the scenario information indicates the input text does not include the key text, add the marker symbols between the adjacent speech texts of any two speakers, and use the input text with the added identity prompt words and the added marker symbols as a fourth semantic enhancement result.

20. The apparatus according to claim 13, wherein the processing circuitry is configured to:
detect a length of the input text;
when the length of the input text is greater than a first preset length threshold, perform feature extraction processing on the input text to obtain statistical features, perform logistic regression processing on the statistical features to obtain the text classification result; and
when the length of the input text is less than or equal to the first preset first length threshold, perform the semantic enhancement processing on the input text.
